(19) United States
(12) Patent Application Publication
(10) Pub. No.: US 2013/0325584 A1
(43) Pub. Date: Dec. 5, 2013

(54) METHODS AND SYSTEMS FOR ATTRIBUTING CHANGES IN AN ADVERTISING METRIC OF INTEREST TO OTHER ADVERTISING METRICS

(71) Applicants: David Taylor Bogaty, San Francisco, CA (US); Mukund Sundararajan, Sunnyvale, CA (US); Chinmay Deepak Karande, San Francisco, CA (US); Yi Sun, San Jose, CA (US)

(72) Inventors: David Taylor Bogaty, San Francisco, CA (US); Mukund Sundararajan, Sunnyvale, CA (US); Chinmay Deepak Karande, San Francisco, CA (US); Yi Sun, San Jose, CA (US)

(21) Appl. No.: 13/488,030

(22) Filed: Jun. 4, 2012

(51) Int. Cl. G06Q 30/02

(52) U.S. Cl. 705/14.41

(57) ABSTRACT

Methods and systems for attributing changes in an advertising metric of interest, such as revenue, to other advertising metrics, are provided. The methods and systems described herein are particularly applicable to advertising provided in online web sites, such as online internet search provider sites. The changes in one or more subordinate online advertising metrics, such as the number of clicks on a particular advertising link, and the cost-per-click to the advertiser, are measured over a predefined period of time, as are the changes in the advertising metric of interest over the same predefined period of time. The respective impacts of the changes of the are determined through the use of sensitivity analysis.

### BACKGROUND OF THE INVENTION

This description relates to online advertising, and, more particularly, to a network-based method and system for identification and extraction of information relating to revenue derived from online advertising.

An online advertising system may provide advertising links (also referred to as “impressions” hereinafter) to users when they visit certain web pages. When a particular advertising link is of interest to a user, a user may select (or click) the advertising link, which may cause the user's web browser to visit a web page belonging to the advertiser associated with the advertising link. This selection of an advertising link by a user is commonly referred to as a “click.”

Online advertising systems typically track impressions and clicks, and calculate charges based thereon. For example, an online advertising system may calculate a charge for displaying an advertiser's advertisement on the system's web page based, at least in part, on the number of clicks that an advertising link receives. Charges for displaying advertisements may also be calculated based on other characteristics as well, such as the value of keywords entered by a user that causes a particular advertisement to be displayed; the time of day; the location, age, or other demographic information associated with the user; or the like. Charges may also be based upon an auction process, in which advertisers bid the amounts that they would be willing to pay, to have their advertisements appear on a web page, such as the web page of an online search provider. The amount of the bid, and other factors, may control the position on the web page that an advertising link appears, as well as the frequency with which the advertising link appears, etc.

It is relevant to the proprietors of the web pages upon which such advertising links appear to be able to monitor income received as a result of “clicks” on advertising links posted on their web pages, and to be able to identify the cause or causes of changes in such revenue.

### BRIEF DESCRIPTION OF THE INVENTION

In an aspect, a computer-implemented method for attributing a change in a primary advertising metric to at least one of at least two secondary advertising metrics is provided. The method comprises identifying a primary advertising metric. The method further comprises recording values of the primary advertising metric at a first time and at a later second time, the first time and the second time defining a selected period of time. The method further comprises determining a change in the primary advertising metric between the first time and the second time. The method further comprises identifying at least two secondary advertising metrics, wherein changes in each of the secondary advertising metrics causes changes in the primary advertising metric. The method further comprises recording values of each of the plurality of secondary advertising metrics at the first time and the second time. The method further comprises determining an aggregate impact value of said one of the at least two secondary advertising metrics on the primary advertising metric for the selected period of time.

In another aspect, one or more non-transitory computer-readable storage media having computer-executable instructions embodied thereon are provided. When executed by at least one processor, the computer-executable instructions cause the processor to prompt a user to identifying a primary advertising metric. The computer-executable instructions further cause the processor to record values of the primary advertising metric at a first time and at a later second time, the first time and the second time defining a selected period of time. The computer-executable instructions further cause the processor to determine a change in the primary advertising metric between the first time and the second time. The computer-executable instructions further cause the processor to prompt a user to identify at least two secondary advertising metrics, wherein changes in each of the secondary advertising metrics causes changes in the primary advertising metric. The computer-executable instructions further cause the processor to record values of each of the plurality of secondary advertising metrics at the first time and the second time. The computer-executable instructions further cause the processor to determine an aggregate impact value of said one of the at least two secondary advertising metrics on the primary advertising metric for the selected period of time.

In another aspect, a computer system is provided, comprising a processor and a computer-readable storage device having encoded thereon computer readable instructions that are executable by the processor. The functions performed by the processor comprise identifying a primary advertising metric. The functions further comprise recording values of the primary advertising metric at a first time and at a later second time, the first time and the second time defining a selected period of time. The functions further comprise determining a change in the primary advertising metric between the first time and the second time. The functions further comprise identifying at least two secondary advertising metrics, wherein changes in each of the secondary advertising metrics causes changes in the primary advertising metric. The functions further comprise recording values of each of the plurality of secondary advertising metrics at the first time and the second time. The functions further comprise determining an aggregate impact value of said one of the at least two secondary advertising metrics on the primary advertising metric for the selected period of time.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a diagram of an exemplary network in which an aspect of the methods and systems described herein may be employed in accordance with one embodiment of the present invention.

FIG. 2 is a diagram of an exemplary advertising system shown in FIG. 1, in which an aspect of the methods and systems described herein may be employed in accordance with one embodiment of the present invention.

FIG. 3 is a flowchart of an exemplary method for attributing changes in an advertising metric of interest to other advertising metrics in accordance with one embodiment of the present invention.

FIG. 4 is a diagram of exemplary computing systems that may be used in the environment shown in FIG. 1 in accordance with one embodiment of the present invention.

Although specific features of various embodiments may be shown in some drawings and not in others, this is for convenience only. Any feature of any drawing may be referenced and/or claimed in combination with any feature of any other drawing.

### DETAILED DESCRIPTION OF THE INVENTION

The following detailed description of implementations consistent with the principles of the invention refers to the accompanying drawings. The same reference numbers in different drawings may identify the same or similar elements. Also, the following detailed description does not limit the invention.

The subject matter described herein relates generally to online advertising. Specifically, the methods and systems herein enable a proprietor of an online website featuring paid advertising in which the proceeds of the advertising are paid to the proprietor of the website to attribute changes in a primary advertising metric of interest (such as revenue) to changes in other secondary advertising metrics (such as the number of appearances or “impressions” of a particular advertising link during a predefined period of time, the number of clicks per the same period of time attributable to that particular advertising link, and the cost-per-click associated with that particular advertising link). That is, the methods and systems described herein determine the approximate relative impact of each of various secondary advertising metrics (such as number of impressions or cost-per-click) upon a primary advertising metric (such as revenue). As used above, “proprietor” may refer to the owner of a website on which online advertising links appear; alternatively, “proprietor” may also refer to an entity whose function is to promote or facilitate the appearance of an advertiser's online advertising link on another party's website.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) identifying a primary advertising metric; b) recording the primary advertising metric at a first time and at a later second time, the first time and the second time defining a selected period of time; c) determining a change in the primary advertising metric between the first time and the second time; d) identifying at least two secondary advertising metrics, wherein changes in each of the secondary advertising metrics causes changes in the primary advertising metric; e) recording each of the plurality of secondary advertising metrics at the first time and the second time; and f) determining an aggregate impact value of at least one secondary advertising metric on the primary advertising metric for the selected period of time.

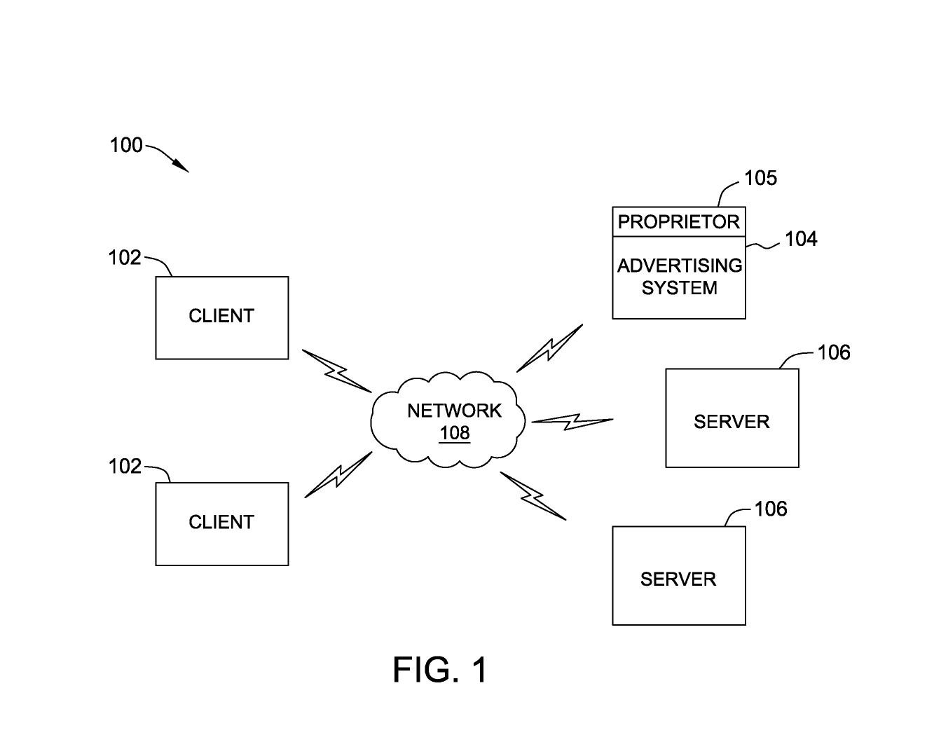

FIG. 1 is an exemplary diagram of a network 100 in which systems and methods consistent with the principles of the invention may be implemented. Network 100 may include multiple clients (or advertisers) 102, an advertising system 104 maintained by proprietor 105, and servers 106 connected via a network 108. Network 108 may include a local area network (LAN), a wide area network (WAN), a telephone network, such as the Public Switched Telephone Network (PSTN), an intranet, the Internet, or a combination of similar or dissimilar networks. Two clients/advertisers 102, one advertising system 104, and two servers 106 have been illustrated as connected to network 108 in FIG. 1 for simplicity. In practice, there may be more or fewer clients 102, advertising systems 104, and/or servers 106. Also, in some instances, a client 102 may perform one or more of the functions of advertising system 104 and/or server 106 and vice versa.

Clients 102 may include client entities. An entity may be defined as a device, such as a personal computer, a wireless telephone, a personal digital assistant (PDA), a lap top, or another type of computation or communication device, a thread or process running on one of these devices, and/or an object executable by one of these devices. Advertising system 104 may include a server entity that maintains and provides advertising links. Servers 106 may include server entities that gather, process, search, and/or maintain data and data files in a manner consistent with the principles of the invention. Clients 102, advertising system 104, and servers 106 may connect to network 108 via wired, wireless, and/or optical connections.

In an implementation consistent with the principles of the invention, servers 106 may optionally include a search engine (not shown) usable by clients 102. While advertising system 104 and servers 106 are shown as separate entities, it may be possible for one or more of servers 106 to perform one or more of the functions of advertising system 104, and vice versa. For example, it may be possible to implement advertising system 104 and one or more of servers 106 as a single server. It may also be possible to implement advertising system 104 as multiple, possibly distributed, entities.

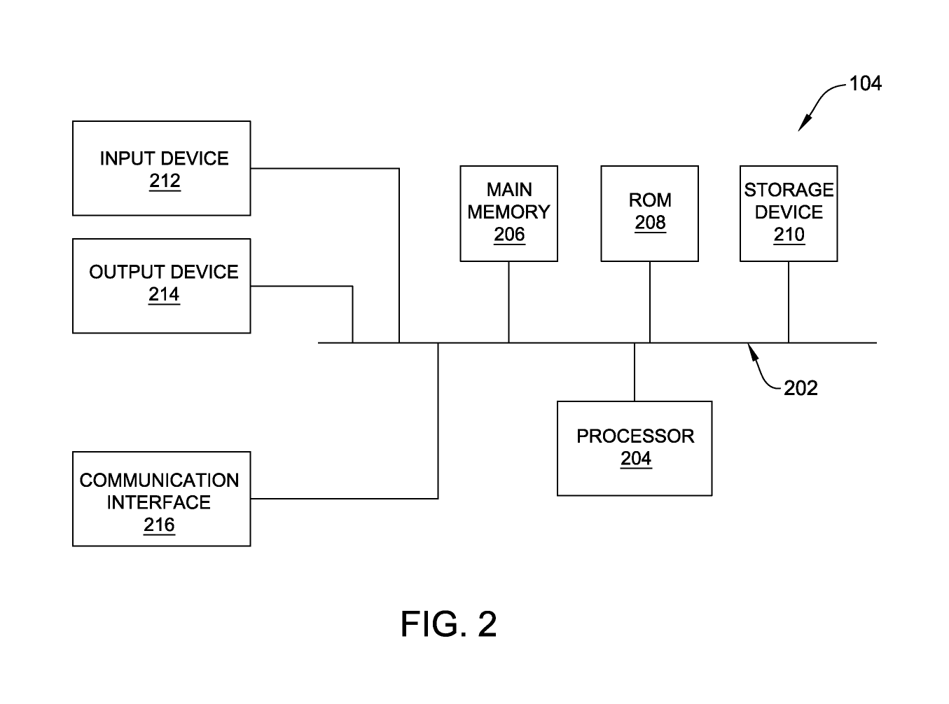

FIG. 2 is an exemplary diagram of advertising system 104 in an implementation consistent with the principles of the invention. Clients 102 and servers 106 may be similarly configured. Advertising system 104 may include a bus 202, a processor 204, a main memory 206, a read only memory (ROM) 208, a storage device 210, an input device 212, an output device 214, and a communication interface 216. Bus 202 may include a path that permits communication among the components of advertising system 104.

Processor 204 may include any type of conventional processor, microprocessor, or processing logic that interprets and executes instructions. Main memory 206 may include a random access memory (RAM) or another type of dynamic storage device that stores information and instructions for execution by processor 204. ROM 208 may include a conventional ROM device or another type of static storage device that stores static information and instructions for use by processor 204. Storage device 210 may include a magnetic and/or optical recording medium and its corresponding drive.

Input device 212 may include a conventional mechanism that permits an operator to input information to, and/or otherwise interact with, advertising system 104, such as a keyboard, a mouse, a pen, a biometric mechanism, such as a voice recognition device, etc. Output device 214 may include a conventional mechanism that outputs information to the operator, including a display, a printer, a speaker, etc. Communication interface 216 may include any transceiver-like mechanism that enables advertising system 104 to communicate with other devices and/or systems. For example, communication interface 216 may include mechanisms for communicating with another device or system via a network, such as network 108.

As will be described in detail below, advertising system 104, consistent with the principles of the invention, facilitates the posting of advertising links on web pages maintained by, for example, an online search provider. Advertising system 104 may perform this and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

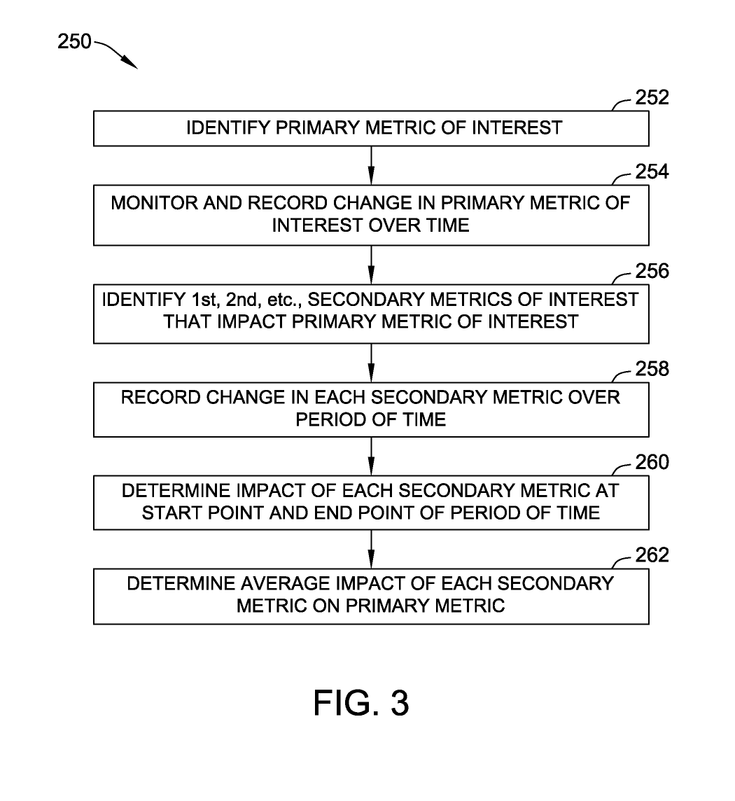

FIG. 3 is a flowchart of an exemplary method 250 employed by advertising system 104 for attributing changes in an advertising metric of interest to other advertising metrics. Advertising system 104 identifies 252 a primary metric of interest, for which additional information is desired, and monitors and records 254 changes in the primary metric of interest over a predefined period of time having a start point and an end point. Advertising system 104 identifies 256 1^{st}, 2^{nd}, etc., secondary metrics of interest that are known to have an impact on (are factors of) the primary metric of interest, and records 258 the change in each secondary metric of interest over the same predefined period of time. Advertising system 104 then determines 260 an aggregate impact value of one of the multiple (at least two) secondary advertising metrics on the primary advertising metric for the selected period of time, through a calculation process employing the use of counterfactuals, as described in further detail herein. In order to determine the impact of each secondary metric on a primary metric of interest, advertising system 104 repeats determination step 260 until the impact of each secondary metric that defines the primary metric of interest is determined.

The following is a description of the analysis underlying the steps needed to carry out exemplary method 250. The revenue of, for example, proprietor 105 of an online search website, such as Google Inc., is derived, in part, from advertisements in the form of advertising links that appear on its web pages. In online advertising, a “Vertical” is a term sometimes used to refer to a category of business that generates revenue, such as advertising for retail sales, advertising for travel-related sales, advertising for financial services, etc. Each Vertical may, in turn, be broken down into the individual products sold under that category. Each product, in turn, may be covered by one or more advertising campaigns, represented by separate advertising links that appear on the web pages of advertising system 104.

An entity, such as proprietor 105 of advertising system 104, is interested in changes in revenue overall, and particularly in identifying the changes in revenue (regardless of the direction of the change), for each Vertical, so that the changes in revenue between Verticals can be compared, and the relative impacts for each Vertical can be compared.

The ability to attribute changes in a primary metric of interest to other secondary metrics of interest may be complicated by the particular mathematical relationship between the primary metric and the secondary metric(s). For example, in the environment of online advertising, the revenue derived from a Vertical is not a simple additive function of cost-per-click (“CPC”) and the raw number of clicks that an advertising link receives during a period of time. This is because the revenue of a Vertical incorporating several products is a function of the cost-per-click for each Product (which may vary over time) multiplied by the number of clicks for each Product over that period of time. In addition, mix-effect issues can complicate the calculation of the contributions made by each secondary metric on a primary metric. For example, the revenue from each Vertical can be further decomposed based on the ad-product (search advertising—advertising that is selected and displayed as a result of an online search conducted by a user, or display advertising—prepaid advertising contracted to appear under specific predefined circumstances). Typically, search clicks are more expensive for an advertiser than display clicks. Accordingly, a change in the proportion of search clicks can increase the revenue of a Vertical for proprietor 105 without any change in the underlying CPC of either the search or the display segment. Therefore, if the impact on revenue is attributed to the simple multiplication of CPC and clicks for a particular Vertical without refining the analysis by products within a Vertical, one would be led to conclude that attribution should solely be assigned to CPCs (signifying an increase in competition, if overall revenue had decreased, for example), whereas the principal actual reason is a change in the proportion of clicks between discrete products within the Vertical.

The amount of revenue is a function of the number of occurrences wherein an advertising link is shown. That is, the revenue is the product of the number of appearances or impressions of an advertising link, the number of clicks on that advertising link, the average cost-per-click to the advertiser, and the click-through-rate. Specifically, the revenue may be broadly calculated as

R=N_{C}·CPC_{AVG}

where

N_{C}=N_{I}·CTR

and R is revenue, CPC_{AVG} is the average cost-per-click, N_{C} is the number of clicks, CTR is the click-through-rate, and N_{I} is the number of impressions. Therefore, a change in the number of clicks and/or cost-per-click could result in a change in revenue.

However, changes in revenue may not be directly correlated to the variables N_{C} and CPC. As discussed above, change in cost-per-click from one point in time to another is not linear, because, among other reasons, the value of a cost-per-click for an advertising link, at the beginning of a set period of time may be and usually is, different from the cost-per-click for that same advertising link at the end of that period of time, and the change in value over that period of time may not be represented by a straight line from beginning to end. Accordingly, the numerical relationship between revenue R and cost-per-click CPC is not additive. That is, when observing the change in revenue from one month to the next, the change in variables N_{C} and CPC may not sum to the total change in revenue. Additionally, because the revenue from a single advertiser may be spread across several campaigns, a change in the proportion of the number of clicks may increase revenue without any change in the cost-per-click of either campaign (i.e., a mix-effect).

Sensitivity analysis is employed to address both non-linearity and mix-effect issues, as discussed below. Sensitivity analysis is the study of how the uncertainty in the output of a model (numerical or otherwise) can be apportioned to different sources of uncertainty in the model input. For example, it is desired to determine the respective impacts of changes in CPC and clicks, for different Verticals, on a change of overall revenue. For example, the data for two consecutive time periods are examined, week (or month, year, day, etc.) 1 (PRE period) and week (or month, year, day, etc.) 2 (POST period). In order to improve the accuracy of the example results, data at a sufficiently precise level of detail is obtained, i.e., at the Vertical×Product level. For each (Vertical, Product) pair, one obtains the average CPC and click stats in the PRE period, as well as the POST period. The higher the level of granularity that is obtained in the data, the more effective the resulting identification and isolation of mix-effects is.

Counterfactuals are commonly utilized to quantify the overall effect on a system that results from changing variables (e.g., secondary metrics) within that system. A counterfactual proposition is a statement that indicates what the result is from an assumed premise, i.e., if X (a condition that may or may not, in fact, be true), then Y (the result assuming X to be true). For a multivariate system (such as the advertising scenarios discussed herein), this effect is determined by (1) holding all but one variable (secondary metric) constant, and (2) recording that one variable's (secondary metric's) impact then (3) repeating steps 1 through 2 for all permutations of potential constant variable (secondary metric) values, then (4) repeating steps 1 through 3 for all variables (secondary metrics), and (5) averaging the results per variable (secondary metric) to obtain an overall impact for each variable (secondary metric). Within the field of advertising metrics, counterfactuals may be used to determine the effect on a primary metric of interest, e.g., revenue that results from a change in other secondary metrics. For a particular Vertical, aggregating the impacts for respective secondary metrics, e.g., CPC and clicks, over all products within that particular Vertical, addresses potential mix-effects.

The following example addresses how a mix effect can influence the determination of relative impact of different secondary metrics on a primary metric. Advertiser 102 contracts with advertising system 104 for two advertising campaigns, campaign A and campaign B. Each campaign has associated with it a number of clicks and cost-per-click (secondary metrics). Assume that the number of clicks and cost-per-click data were recorded for the current month, February (POST), and the preceding month, January (PRE). Proprietor 105 of advertising system 104 would like to determine, from these data, the revenue (primary metric) generated by the advertiser 102 in January and February, and explain how and/or why this revenue changed from January to February.

TABLE I
ADVERTISER AVERAGE CPC DATA

| Metric | January | February |
|---|---|---|
| N_{CA} | 20 | 30 |
| CPC_{A} | $1 | $1 |
| N_{CB} | 10 | 10 |
| CPC_{B} | $2 | $2 |

The overall cost-per-click for advertiser 102, an aggregate of the cost-per-click for each advertising campaign, is calculated as

$${CPC}_{AVG} = \frac{( {CPC}_{A} \cdot {N}_{CA} ) + ( {CPC}_{B} \cdot {N}_{CB} )}{( {N}_{CA} + {N}_{CB} )}$$

where CPC_{A} and N_{CA} are the cost-per-click and number of clicks for campaign A, and CPC_{B} and N_{CB} are the cost-per-click and number of clicks for campaign B. The overall cost-per-click distinguishes between situations where changes in the proportion of the number of clicks were present versus changes in the cost-per-click. For the example data in Table I, the average cost-per-click for January is calculated as

$$January ( {CPC}_{AVG} ) = \frac{( 1 \cdot 20 ) + ( 2 \cdot 10 )}{( 20 + 10 )} = \frac{4}{3} \approx 1.33$$

and the average cost-per-click for February is calculated as

$$February ( {CPC}_{AVG} ) = \frac{( 1 \cdot 30 ) + ( 2 \cdot 10 )}{( 30 + 10 )} = \frac{5}{4} = 1.25$$

Comparing January(CPC_{AVG}) to February(CPC_{AVG}) reveals that the average cost-per-click decreased from January to February. However, the cost-per-click remained constant from January to February, i.e.,

January(CPC_{A})=February(CPC_{A})

and

January(CPC_{B})=February(CPC_{B})

but the average cost-per-click changed. Accordingly, a mix-effect is present between average cost-per-click and the number of clicks.

Table II below, and the accompanying discussion, further illustrates the use of counterfactuals in attributing changes in a primary metric of interest (revenue) on secondary metrics (CPC and Clicks).

TABLE II
ADVERTISER WITH SINGLE CAMPAIGN DATA

| Metric | PRE (1) | POST (2) |
|---|---|---|
| CPC | $1 | $2 |
| N_{C} | 10 | 30 |

As an example, assume advertiser 102 contracts with proprietor 105 of advertising system 104 for a single advertising campaign. A set of counterfactuals for cost-per-click and number of clicks may be used to determine their impact on revenue. The overall impact of cost-per-click on revenue is calculated by averaging a first impact

I₁(CPC)=R(N_{C1}·CPC₂)−R(N_{C1}·CPC₁)=(10·2)−(10·1)=$10

and a second impact

I₂(CPC)=R(N_{C2}·CPC₂)−R(N_{C2}·CPC₁)=(30·2)−(30·1)=$30

to obtain

$${I}_{overall} ( CPC ) = \frac{{I}_{1} ( CPC ) + {I}_{2} ( CPC )}{2} = \frac{10 + 30}{2} = \$20$$

where N_{C1} is the number of clicks for the PRE period, N_{C2} is the number of clicks for the POST period, CPC₁ is the cost-per-click for the PRE period, and CPC₂ is the cost-per-click for the POST period.

Similarly, the overall impact of number of clicks on revenue is determined by averaging a first impact

I₁(N_{C})=R(N_{C2}·CPC₁)−R(N_{C1}·CPC₁)=(30·1)−(10·1)=$20

and a second impact

I₂(N_{C})=R(N_{C2}·CPC₂)−R(N_{C1}·CPC₂)=(30·2)−(10·2)=$40

to obtain

$${I}_{overall} ( {N}_{C} ) = \frac{{I}_{1} ( {N}_{C} ) + {I}_{2} ( {N}_{C} )}{2} = \frac{20 + 40}{2} = \$30$$

where N_{C1} is the number of clicks for the PRE period, N_{C2} is the number of clicks for the POST period, CPC₁ is the cost-per-click for the PRE period, and CPC2 is the cost-per-click for the POST period.

Summing the overall impact of cost-per-click and number of clicks yields a total impact of $50. This total equals the overall change in revenue

Rₒᵥₑᵣₐₗₗ=R(N_{C2}·CPC₂)−R(N_{C1}·CPC₁)=(30·2)−(10·1)=$50

and thus the impacts of changing cost-per-click and changing number of clicks on revenue have been accurately quantified.

The just-described method for determining the overall impact of each metric on revenue is particularly applicable in the environment of an advertising system 104 having one or more advertisers 102, wherein each advertiser 102 has multiple advertising campaigns. For example, advertiser 102 is contracted with proprietor 105 of advertising system 104 for two advertising campaigns, A and B. For this example, number of clicks and cost-per-click data, shown in Table III, is collected, representing data at the start point of a predefined period of time (“PRE”), and at the end point of a predefined period of time (“POST”).

TABLE III
ADVERTISER METRIC DATA

| Metric | PRE (1) | POST (2) |
|---|---|---|
| N_{CA} | 20 | 60 |
| CPC_{A} | $1 | $1 |
| N_{CB} | 20 | 20 |
| CPC_{B} | $2 | $2 |

The overall impact for each metric is calculated by summing, for the metric of interest, the impact per campaign, i.e., (1) calculate the impact per metric for each campaign separately and then (2) sum the results to obtain the overall impact per metric. Thus, the method begins by calculating the impact for each metric per campaign.

For the current example, the impact of cost-per-click on revenue for campaign A is calculated using the equation

$${I}_{A} ( CPC ) = \frac{{I}_{A 1} ( CPC ) + {I}_{A 2} ( CPC )}{2}$$

where

I_{A1}(CPC)=(CPC_{A2}·N_{C1})−(CPC_{A1}·N_{C1})=(1·20)−(1·20)=0

and

I_{A2}(CPC)=(CPC_{A2}·N_{C2})−(CPC_{A1}·N_{C2})−(1·60)−(1·60)=0

to obtain

$${I}_{A} ( CPC ) = \frac{0 + 0}{2} = \$0$$

Similarly, the impact of number of clicks on revenue for campaign A is calculated using the equation

$${I}_{A} ( {N}_{C} ) = \frac{{I}_{A 1} ( {N}_{C} ) + {I}_{A 2} ( {N}_{C} )}{2}$$

where

I_{A1}(N^{C})=(CPC_{A1}·N_{C2})−(CPC_{A1}·N_{C1})=(1·60)−(1·20)=40

and

I _{A2}(N_{C})=(CPC_{A2}·N _{C2})−(CPC_{A2}·N_{C1})≦(1·60)−(1·20)=40

to obtain

$${I}_{A} ( {N}_{C} ) = \frac{40 + 40}{2} = \$40$$

The impact of each metric for campaign B is obtained by repeating the method used to obtain the impact of each metric for campaign A. As a result, the impact of cost-per-click on revenue for campaign B is

I_{B}(CPC)=$0

and the impact of number of clicks on revenue for campaign B is

I_{B}(N_{C})=$0

The results from campaign A and campaign B are summed to determine the overall impact of each metric on revenue. As a result, the overall impact of cost-per-click on revenue is

Iₒᵥₑᵣₐₗₗ(CPC)=I_{A}(CPC)+I_{B}(CPC)=0+0=0

and the overall impact of number of clicks on revenue is

I ₒᵥₑᵣₐₗₗ(N_{C})=I_{A}(N_{C})+I_{B}(N_{C})=40+0=$40

The overall impact for each metric can be summed to calculate the total change in revenue from PRE to POST. This calculation results in a total change in revenue of

Rₜₒₜₐₗ=Iₒᵥₑᵣₐₗₗ(CPC)+Iₒᵥₑᵣₐₗₗ(N_{C})’0+40=$40

which can be verified by comparison with the total change in revenue when calculated directly. To calculate the total change in revenue directly, the revenue for PRE

R_{PRE}=(N_{A1}·CPC_{A1})+(N_{B1}·CPC_{B1})=(20·1)+(20·2)=$60

is subtracted from the revenue for POST

R_{POST}(N_{A2}·CPC_{A2})+(N_{B2}·CPC_{B2})=(60·1)+(20·2)=$100

to obtain

Rₜₒₜₐₗ=R_{POST}−R_{PRE}=100−60=$40

being the total change in revenue. A comparison of this result to the previously calculated result shows that they are equivalent, demonstrating the effectiveness of the disclosed method for determining the overall impact of each metric on revenue.

The foregoing analysis may be more generally stated in the following manner. In general, one assumes the space of analysis S (revenue) to be a cross-product of a set D of ‘d’ dimensions (e.g., Verticals, Products in each Vertical, etc.). That is, each entity in the space of analysis is a d-tuple (x₁, . . . , x_{d}) where xᵢ is an element from the i'th dimension. The elements in each dimension are arranged in a hierarchical manner, with Rᵢ being the root of the i'th dimension hierarchy and the lowest level elements in being called ‘leaf’-elements. An entity (in the context of this explanation, namely y₁, . . . , y_{d}) is a ‘leaf’ entity if each yᵢ is a leaf element in the i'th dimension. With these definitions, the set of all leaf entities in the space is a partition of the space.

One may express the metric of interest M over the entire space of analysis as a function of all the secondary metric values M_{T1}, . . . , M_{Tk} for all leaf entities T in the space.

M=f(U_{T}{M_{T1}, . . . , M_{Tk}})

One then considers an ordering of U_{T} {M_{T1}, . . . , M_{Tk}} and further considers the hypothetical alternative calculations of the impact of each metric in which the numerical values for the metrics are changed from PRE to POST values in the order in which they appear in the different successive orderings. One performs this operation for all possible orderings, and determines the average of the individual impact value assigned to each M_{Tj} to obtain the ‘attribution’ of the overall change in M attributable due to the change in M_{Tj}

However, in “real world” applications of these principles, the number of secondary metrics that actually impact upon a primary metric such as revenue, such as the advertisers and advertising links present on an advertising system's website, can number in the hundreds of thousands or millions. Performing the previously-described permutations would be beyond the capacity of conventional computation devices. Accordingly, an approach is needed to simplify the computation process. When the number of secondary metrics is large (i.e., greater than about 15), it is often due to the fact that the various secondary metrics belong to different subspaces of the overall space over which the primary metric is defined. The revenue of a proprietor 105's online advertising website is the sum of the revenue derived from all of its advertisers (also referred to as “submarkets”). The average CPC for advertising links appearing on the website of proprietor 105's web pages is a weighted average of each of the proprietor's advertisers' CPCs. In each of these examples, there are millions of secondary metrics, with a few belonging to each advertiser.

For additive metrics—any metric expressible as a count (a non-negative integer), such as revenue, clicks, impressions—the metric value at a higher level entity in the space (e.g., a vertical) is simply the sum of the metric values at a canonical set of lower level entities (e.g., vertical, product pairs). That is, one may compute the impact of each advertiser's secondary metrics for that advertiser's primary metric only, and the resultant impact value is the same as the impact value of that secondary metric on the overall primary metric. In particular,

M=Σ_{Tg}(M_{T1}, . . . , M_{Tk})

where the summation is over all the leaf entities in the space.

It can be proven that for additive metrics, the attribution value for the j'th metric computed by the generalized method defined above is equal to the sum of attribution values assigned to the j'th metric when the generalized method is applied to each of the leaf entities in the space. This produces tremendous computational speed-up, since the generalized method applied to the entire space requires N_{T}k*(N_{T}k)! operations, whereas the latter approach requires only N_{T}*(k)! operations. Further, for examples such as above where the metric of interest is a product of the secondary metrics (revenue=CPC*clicks), one is able to implement this method in only N_{T}k³ operations.

For non-additive metrics, one would need to compute these alternative combinations or counterfactuals over millions of secondary metrics in order to determine an exact numerical value for each impact. However, because secondary metrics may be grouped according to advertisers, one does not need to consider all possible counterfactuals (several orders of magnitude higher than the number of secondary metrics alone). Instead, one may still make the generalized method computationally feasible by not averaging over all possible permutations, but just sufficiently many randomly sampled permutations. It has been demonstrated that a sampling on the order of 10⁴ permutations of counterfactuals is sufficient to enable sufficiently accurate calculation of the impact of secondary metrics of interest. The use of less than all possible permutations is believed permissible because not all secondary metrics are interrelated and accordingly do not influence one another. In particular, it has been found that if approximately 10⁴ permutations of counterfactuals are calculated, those calculations do not yield results that change significantly, if a greater number of permutations are calculated. That is, the results stabilize, once approximately 10⁴ permutations have been calculated. Accordingly, the computation of impacts of secondary metrics is significantly simplified and accelerated.

The following chart identifies various applications for the method and system described herein (which include the revenue application), as well as the insights provided to one analyzing the results of the respective subject applications:

| | | Characteristic | |
|---|---|---|---|
| Application | Dimensions (D) | Function(f) | Insights |
| Advertising | Vertical, | Revenue= | Identifies how |
| System | Products, | Impressions | much each |
| Proprietor | Channels, | *CTR*CPC | auction metric |
| Revenue | Region | where CTR = | contributed to |
| | | click- | revenue change. |
| | | through-rate) | This helps |
| | | | identify who |
| | | | among proprietor |
| | | | 105 of |
| | | | advertising |
| | | | system 104, |
| | | | advertisers |
| | | | 102, or users |
| | | | 103 drove a |
| | | | revenue change. |
| Advertiser's | Campaigns--> | Clicks= | Helps |
| Clicks | AdGroups--> | Impressions | distinguish |
| | Keywords | *CTR | the type of |
| | descriptive | | advertiser/ |
| | words used to | | user activity |
| | target | | that caused a |
| | advertisements | | variation in |
| | to relevant | | clicks |
| | web pages), | | |
| | Networks, | | |
| | Regions | | |
| Advertisers' | Same as above | Overall CPC = | Distinguishes |
| CPC | | weighted sum of | Between |
| | | within segment | changes in |
| | | CPCs; weights | overall CPC |
| | | are the | that occur |
| | | proportion of | Because of a |
| | | clicks | change in |
| | | | proportion of |
| | | | clicks, versus |
| | | | changes in |
| | | | underlying |
| | | | CPC (more |
| | | | indicative of |
| | | | true change in |
| | | | auction |
| | | | competition) |
| Salesperson's | (Pod-->Company, | Revenue = | Allows |
| Accounts | CID), AdProducts | Impressions | salespersons |
| | | *CTR*CPC | to understand |
| | | | why revenue |
| | | | changed, and |
| | | | prioritize |
| | | | their activity |
| | | | accordingly |

The foregoing detailed description illustrates embodiments of the invention by way of example and not by way of limitation. It is contemplated that the invention has general application to the processing of various forms of advertising metrics, such as those described above, and also to other advertising-related metrics as described in the foregoing chart, such as advertiser's clicks (the identification of which helps distinguish the type of advertiser/user activity that causes a variation in the total number of clicks received on advertisers' advertising links); advertisers' cost-per-click (distinguishes between changes in overall CPC that occur purely because of a change in the relative proportions of clicks on various advertising links, as compared to changes in underlying CPC; and sales persons' accounts (which allows salespersons to understand why revenue attributable to them changed, and prioritize their sales activities accordingly. In addition, it is contemplated that the invention has application to other areas. In the space of consumer web technology, these techniques could be applied to analysis of the online search engine operated by the same proprietor. For example, in analyzing the number of clicks on search engine results in a given day, one could deconstruct the overall number of clicks into the number of users performing searches, multiplied by the number of searches performed by each user, multiplied by the average likelihood that a user clicks on a search result for a given search query. The same analysis could be applied to attribute the change in clicks between two periods of time to the underlying variable that was responsible.

These techniques could also be applied generally to any situation where primary and secondary metrics are analyzed. For example, in analyzing the revenue of a chain of car dealerships, one could deconstruct the revenue into the number of potential customers entering dealerships in a month, multiplied by the percent of those customers who purchased vehicles, multiplied by the average purchase price of the vehicles they purchased. A similar analysis could be applied to attribute the change in revenue between two periods of time to the underlying variable that was responsible. These are only examples of areas in which the principles of the present invention may be applicable, and the invention is not construed to be limited thereto.

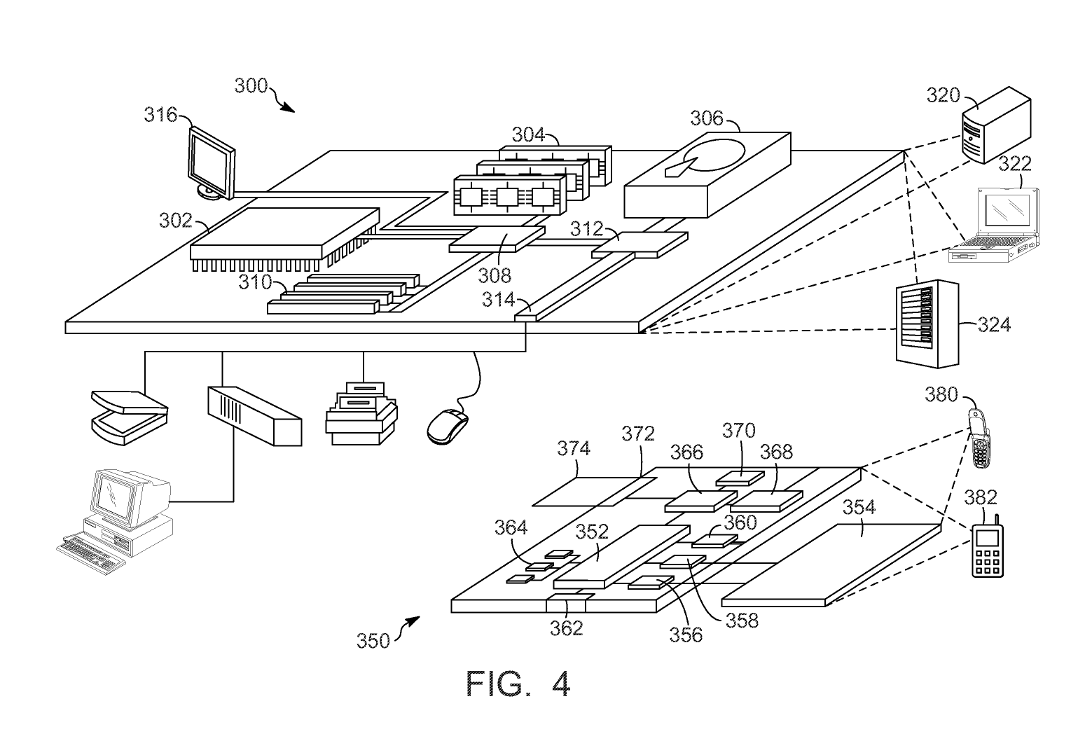

FIG. 4 is a diagram of exemplary computing devices 300 and 350 that may be used in the environment shown in FIG. 1. More specifically, FIG. 4 shows an example of a generic computing device 300 and a generic mobile computing device 350, which may be used with the techniques described here. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a volatile memory unit or units. In another implementation, the memory 304 is a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of functions is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can execute instructions within the computing device 350, including instructions stored in the memory 364. The processor may be implemented as a chipset of chips that include separate and multiple analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD (Thin-Film-Transistor Liquid Crystal Display) or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provide in communication with processor 352, so as to enable near area communication of device 350 with other devices. External interface 362 may provide, for example, for wired communication in some implementations, or for wireless communication in other implementations, and multiple interfaces may also be used.

The memory 364 stores information within the computing device 350. The memory 364 can be implemented as one or more of a computer-readable medium or media, a volatile memory unit or units, or a non-volatile memory unit or units. Expansion memory 374 may also be provided and connected to device 350 through expansion interface 372, which may include, for example, a SIMM (Single In Line Memory Module) card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provide as a security module for device 350, and may be programmed with instructions that permit secure use of device 350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352 that may be received, for example, over transceiver 368 or external interface 362.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS (Global Positioning system) receiver module 370 may provide additional navigation- and location-related wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smart phone 382, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing systems 300 and 352 are configured to receive and/or retrieve data pertaining to advertisers, advertising links or impressions corresponding to those advertisers that appear on an entity's web page, and metrics corresponding to the appearance of those impressions on that entity's web page, such as the frequency of the impressions over a predefined period of time, the cost-per-click for each impression (monitored over a period of time), etc., from various other computing devices connected to computing devices 300 and 352 through a communication network, and store this data within at least one of memory 304, storage device 306, and memory 364. Computing systems 300 and 352 are further configured to manage and organize the data within at least one of memory 304, storage device 306, and memory 364 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for attributing a change in a primary advertising metric to at least one of at least two secondary advertising metrics, the method comprising:
identifying a primary advertising metric;
recording values of the primary advertising metric at a first time and at a later second time, the first time and the second time defining a selected period of time;
determining a change in the primary advertising metric between the first time and the second time;
identifying at least two secondary advertising metrics, wherein changes in each of the secondary advertising metrics causes changes in the primary advertising metric;
recording values of each of the plurality of secondary advertising metrics at the first time and the second time; and
determining an aggregate impact value of said one of the at least two secondary advertising metrics on the primary advertising metric for the selected period of time.

2. A computer-implemented method in accordance with claim 1, wherein determining an aggregate impact value of said one of the at least two secondary advertising metrics on the primary advertising metric for the selected period of time comprises:
determining successive intermediary impact values for said one of the at least two secondary advertising metrics, and
aggregating the successive intermediary impact values.

3. A computer-implemented method in accordance with claim 2 wherein determining successive intermediary impact values for said one of the at least two secondary advertising metrics comprises:
defining a plurality of counterfactuals for said one of the at least two secondary advertising metrics, each counterfactual associated with a plurality of possible permutations for calculating possible impact of each respective secondary advertising metric; and
performing a calculation of the impact of each secondary advertising metric, for each of at least a portion of said plurality of possible permutations.

4. A computer-implemented method in accordance with claim 3, wherein defining a plurality of counterfactuals for said one of the at least two secondary advertising metrics, each counterfactual associated with a plurality of possible permutations for calculating possible impact of each respective secondary advertising metric, comprises:
successively calculating the impact of said one of the at least two secondary advertising metrics by maintaining a value of said one of the at least two secondary advertising metrics constant, and by successively changing a value of another of the at least two secondary advertising metrics from a first time value to a second time value.

5. A computer-implemented method in accordance with claim 4, wherein successively calculating the impact of said one of the at least two secondary advertising metrics by maintaining a value of said one of the at least two secondary advertising metrics constant, and by successively changing a value of another of the at least two secondary advertising metrics from a first time value to a second time value comprises:
repeating the calculation of the impact of said one of the at least two secondary advertising metrics for at least a portion of a total number of said plurality of possible permutations for calculating possible impact of each respective secondary advertising metric.

6. A computer-implemented method in accordance with claim 5, wherein said portion of said plurality of possible permutations comprises about ten thousand permutations.

7. A computer-implemented method in accordance with claim 1, wherein said primary metric of interest comprises:
one of revenue derived from placement of online advertising links on the website of a proprietor of an advertising system, number of clicks on an advertiser's advertising link, the overall cost-per-click for the advertising links of an advertiser.

8. A computer-implemented method in accordance with claim 1, wherein said plurality of secondary advertising metrics comprises:
at least two of cost-per-click, click-through-rate, impressions, number of searches performed by users of an online search website, likelihood of a user to click on a search result for a specified search.

9. A computer-implemented method in accordance with claim 1 wherein determining an aggregate impact value of said one of the at least two secondary advertising metrics on the primary advertising metric for the selected period of time comprises:
determining an aggregate impact of each of the at least two secondary advertising metrics on the primary advertising metric for the selected period of time.

10. One or more non-transitory computer-readable storage media having computer-executable instructions embodied thereon, wherein, when executed by at least one processor, the computer-executable instructions cause the processor to:
prompt a user to identifying a primary advertising metric;
record values of the primary advertising metric at a first time and at a later second time, the first time and the second time defining a selected period of time;
determine a change in the primary advertising metric between the first time and the second time;
prompt a user to identify at least two secondary advertising metrics, wherein changes in each of the secondary advertising metrics causes changes in the primary advertising metric;
record values of each of the plurality of secondary advertising metrics at the first time and the second time; and
determine an aggregate impact value of said one of the at least two secondary advertising metrics on the primary advertising metric for the selected period of time.

11. The computer-readable storage media in accordance with claim 10, wherein the computer-executable instructions cause the processor to:
determine successive intermediary impact values for said one of the at least two secondary advertising metrics, and
aggregate the successive intermediary impact values.

12. The computer-readable storage media in accordance with claim 11, wherein the computer-executable instructions cause the processor to:
define a plurality of counterfactuals for said one of the at least two secondary advertising metrics, each counterfactual associated with a plurality of possible permutations for calculating possible impact of each respective secondary advertising metric; and
perform a calculation of the impact of each secondary advertising metric, for each of at least a portion of said plurality of possible permutations.

13. The computer-readable storage media in accordance with claim 12, wherein the computer-executable instructions cause the processor to:
successively calculate the impact of said one of the at least two secondary advertising metrics by maintaining a value of said one of the at least two secondary advertising metrics constant, and by successively changing a value of another of the at least two secondary advertising metrics from a first time value to a second time value.

14. The computer-readable storage media in accordance with claim 13, wherein the computer-executable instructions cause the processor to:
repeat the calculation of the impact of said one of the at least two secondary advertising metrics for at least a portion of a total number of said plurality of possible permutations for calculating possible impact of each respective secondary advertising metric.

15. The computer-readable storage media in accordance with claim 14, wherein said portion of said plurality of possible permutations comprises about ten thousand permutations.

16. The computer-readable storage media in accordance with claim 10, wherein said primary advertising metric of interest comprises:
one of revenue derived from placement of online advertising links on the website of a proprietor of an advertising system, number of clicks on an advertiser's advertising link, the overall cost-per-click for the advertising links of an advertiser.

17. The computer-readable storage media in accordance with claim 10, wherein said plurality of secondary advertising metrics comprises:
at least two of cost-per-click, click-through-rate, impressions, number of searches performed by users of an online search website, likelihood of a user to click on a search result for a specified search.

18. The computer-readable storage media in accordance with claim 10, wherein the computer-executable instructions cause the processor to:
determine an aggregate impact of each of the at least two secondary advertising metrics on the primary advertising metric for the selected period of time.

19. A computer system comprising:
a processor; and
a computer-readable storage device having encoded thereon computer readable instructions that are executable by the processor to perform functions comprising:
identifying a primary advertising metric;
recording values of the primary advertising metric at a first time and at a later second time, the first time and the second time defining a selected period of time;
determining a change in the primary advertising metric between the first time and the second time;
identifying at least two secondary advertising metrics, wherein changes in each of the secondary advertising metrics causes changes in the primary advertising metric;
recording values of each of the plurality of secondary advertising metrics at the first time and the second time; and
determining an aggregate impact value of said one of the at least two secondary advertising metrics on the primary advertising metric for the selected period of time.

20. A computer system in accordance with claim 19, wherein determining an aggregate impact value of said one of the at least two secondary advertising metrics on the primary advertising metric for the selected period of time comprises:
determining successive intermediary impact values for said one of the at least two secondary advertising metrics, and aggregating the successive intermediary impact values.

21. A computer system in accordance with claim 20 wherein determining successive intermediary impact values for said one of the at least two secondary advertising metrics comprises:
defining a plurality of counterfactuals for said one of the at least two secondary advertising metrics, each counterfactual associated with a plurality of possible permutations for calculating possible impact of each respective secondary advertising metric; and
performing a calculation of the impact of each secondary advertising metric, for each of at least a portion of said plurality of possible permutations.

22. A computer system in accordance with claim 21, wherein defining a plurality of counterfactuals for said one of the at least two secondary advertising metrics, each counterfactual associated with a plurality of possible permutations for calculating possible impact of each respective secondary advertising metric, comprises:
successively calculating the impact of said one of the at least two secondary advertising metrics by maintaining a value of said one of the at least two secondary advertising metrics constant, and by successively changing a value of another of the at least two secondary advertising metrics from a first time value to a second time value.

23. A computer system in accordance with claim 22, wherein successively calculating the impact of said one of the at least two secondary advertising metrics by maintaining a value of said one of the at least two secondary advertising metrics constant, and by successively changing a value of another of the at least two secondary advertising metrics from a first time value to a second time value comprises:
repeating the calculation of the impact of said one of the at least two secondary advertising metrics for at least a portion of a total number of said plurality of possible permutations for calculating possible impact of each respective secondary advertising metric.

24. A computer system in accordance with claim 23, wherein said portion of said plurality of possible permutations comprises about ten thousand permutations.

25. A computer system in accordance with claim 19, wherein said primary metric of interest comprises:
one of revenue derived from placement of online advertising links on the website of a proprietor of an advertising system, number of clicks on an advertiser's advertising link, the overall cost-per-click for the advertising links of an advertiser.

26. A computer system in accordance with claim 19, wherein said plurality of secondary advertising metrics comprises:
at least two of cost-per-click, click-through-rate, impressions, number of searches performed by users of an online search website, likelihood of a user to click on a search result for a specified search.

27. A computer system in accordance with claim 19 wherein determining an aggregate impact value of said one of the at least two secondary advertising metrics on the primary advertising metric for the selected period of time comprises:
determining an aggregate impact of each of the at least two secondary advertising metrics on the primary advertising metric for the selected period of time.
